(19) United States
(12) Patent Application Publication
(10) Pub. No.: US 2004/0242214 A1
(43) Pub. Date: Dec. 2, 2004

(54) Call saving method and telephone switchboard used in telephone switching system

(75) Inventor: Tsutomu Shibata, Tokyo (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/855,504

(22) Filed: May 28, 2004

(30) Foreign Application Priority Data
May 30, 2003 (JP) 2003-154839

(51) Int. Cl. H04M 3/42

(52) U.S. Cl. 455/417

(57) ABSTRACT

Provided is a call saving method and a telephone switchboard used in a telephone switching system capable of saving a call when an incoming call arrives at a portable telephone terminal via an access point and the portable telephone terminal does not respond. When the telephone switchboard detects no response of the portable telephone terminal to the incoming call, an access point that accommodates the portable telephone terminal within an access area makes an inquiry to a portable telephone terminal location management device, and, based on given operation rules, forwards the call going to the portable telephone terminal to a fixed telephone device arranged proximal to an access point specified in a proximal fixed telephone device list table.

### CROSS-REFERENCE TO RELATED APPLICATIONS

This application is based upon and claims the benefit of priority from the prior Japanese Patent Application No. 2003-154839, filed on May 30, 2003; the entire contents of which are incorporated herein by reference.

### BACKGROUND OF THE INVENTION

1. Field of the Invention

The present invention relates to a call saving method and a telephone switchboard used in a telephone switching system, and more particularly to a call saving method and a telephone switchboard used in a telephone switching system arranged such that, when an incoming call arrives at a portable telephone terminal via an access point and the portable telephone terminal does not respond, the incoming call going to the portable telephone terminal is forwarded to a fixed telephone device that is proximal to an access point, whereby saving the incoming call.

2. Description of the Related Art

A technique relating to a conventional telephone switching system is disclosed in “Switching System, Portable Telephone Device and Switchboard” described in Japanese Patent Application Laid-Open No. 2003-46645.

The invention in Japanese Patent Application Laid-Open No. 2003-46645 has a packet switching network for performing communications by switching packets, a circuit switching network for performing communications by switching circuit lines, a switchboard accommodating an extension telephone device and a portable telephone device owned by a user of the extension telephone device. When an operation is performed to turn on a power supply of the extension telephone device, the switchboard sets a no response program to the portable telephone device, and furthermore, sets unresponded call forwarding to a mobile switching station accommodating the portable telephone device, so that the call to which the portable telephone device did not respond is forwarded to the switchboard.

In this state, when an incoming call arrives at the portable telephone device from a telephone device having a function for notifying the caller's number, the portable telephone terminal's telephone number and the telephone device's telephone number are transmitted to the switchboard, and are forwarded to the extension telephone device.

Accordingly, the invention is such that even when communicating to a party that has/manages an extension telephone device and a portable telephone device, the caller can transmit information to the party just by initiating the call to the portable telephone device.

However, according to the constitution of the invention of the above-mentioned Japanese Patent Application Laid-Open No. 2003-46645, since the destination to forward the call going to the portable telephone device is automatically set in the extension telephone device whose power supply is turned on, there is a problem that when the holder of the portable telephone device from which the call is forwarded moves away from the extension telephone device whose power supply is turned on, the function for forwarding the incoming call cannot be utilized effectively.

### SUMMARY OF THE INVENTION

An object of the present invention is to provide a call saving method and a telephone switchboard for use in a telephone switching system arranged such that, when an incoming call arrives at a portable telephone terminal via an access point and the portable telephone terminal does not respond, the incoming call going to the portable telephone terminal is forwarded to a fixed telephone device that is proximal to an access point, whereby saving the incoming call.

In order to achieve the above-mentioned object, an aspect of the present invention provides a call saving method used in a telephone switching system having a telephone switchboard accommodating a plurality of access points for connecting to a plurality of portable telephone terminals, and a plurality of fixed telephone devices, comprising: storing in which access point's range the portable telephone terminal is present while linking the portable telephone terminal and the access point; specifying, when an incoming call arrives at the portable telephone terminal via the access point based on the stored information and the portable telephone terminal does not respond, at least one fixed telephone device proximal to the access point; and forwarding the incoming call going to the portable telephone terminal to the specified fixed telephone device.

Another aspect of the present invention provides a telephone switchboard in a telephone switching system accommodating a plurality of access points for connecting to a plurality of portable telephone terminals, and a plurality of fixed telephone devices, the telephone switchboard comprising: portable telephone terminal location storing unit that stores in which access point's range the portable telephone terminal is present while linking the portable telephone terminal and the access point; fixed telephone device specifying unit that specifies at least one fixed telephone device proximal to the access point when an incoming call arrives at the portable telephone terminal via the access point based on the stored information in the portable telephone terminal location storing unit and the portable telephone terminal does not respond; and call forwarding unit that forwards the incoming call going to the portable telephone terminal to the fixed telephone device specified by the fixed telephone device specifying unit.

By adopting this construction, when the portable telephone device cannot respond, the incoming call can be forwarded sequentially in a given order, or simultaneously, to fixed telephone devices arranged proximal to the access point currently accommodating the non-responding portable telephone terminal. Therefore, as compared to conventional telephone switching system where the forwarding destination is managed in a fixed fashion, call saving with respect to no response of the call-receiving portable telephone terminal can be performed with a high level of probability.

### BRIEF DESCRIPTION OF THE DRAWINGS

FIG. 1 is a system configuration diagram showing a first constructional example of a telephone switching system of the present invention;

FIG. 2 is a block diagram showing a control configuration of the telephone switchboard shown in FIG. 1;

FIG. 3 is a block diagram showing an example of a control configuration of a portable telephone terminal location management device, in the telephone switching system of the present invention;

FIG. 4 is a block diagram showing an example of a control configuration of an access point, in the telephone switching system of the present invention;

FIG. 5 is a block diagram showing an example of a control configuration of a portable telephone terminal, in the telephone switching system of the present invention;

FIG. 6 is a diagram showing an example of data registered in a portable telephone terminal location management table stored in the portable telephone terminal location management device;

FIG. 7 is a diagram showing an example of data registered in a fixed telephone device list table stored by the telephone switchboard;

FIG. 8 is a diagram showing an example of data registered in an access point list table stored by the portable telephone terminal location management device;

FIG. 9 is a diagram showing an example of data registered in an access point proximal fixed telephone device list table stored and managed by the telephone switchboard;

FIG. 10 is a diagram showing an example of data registered in a portable telephone terminal no-response operation rule table stored by the telephone switchboard;

FIG. 11 is a flowchart showing a processing sequence when a call initiation request to a telephone device accommodated by the telephone switchboard is received via a telephone network, in the telephone switching system shown in FIG. 1;

FIG. 12 is a flowchart showing a processing sequence when a call initiation request to a telephone device accommodated by the telephone switchboard is received via a telephone network, in the telephone switching system shown in FIG. 1;

FIG. 13 is a second system configuration diagram of a case where, as a second configuration of the telephone switching system of the present invention, model types of fixed telephone devices accommodated by the telephone switchboard accommodate include, in addition to an IP telephone device, a digital telephone device and an analog telephone device, which connect to a circuit switching network and performs communications by switching circuit lines;

FIG. 14 is a block diagram showing a second control configuration of the telephone switchboard based on the system configuration in FIG. 13; and

FIG. 15 is a diagram showing a second example of data registered in the fixed telephone device management table.

### DETAILED DESCRIPTION OF THE INVENTION

Below, detailed explanation is given regarding embodiments of a telephone switchboard and a telephone switching system of the present invention, with reference made to the attached drawings.

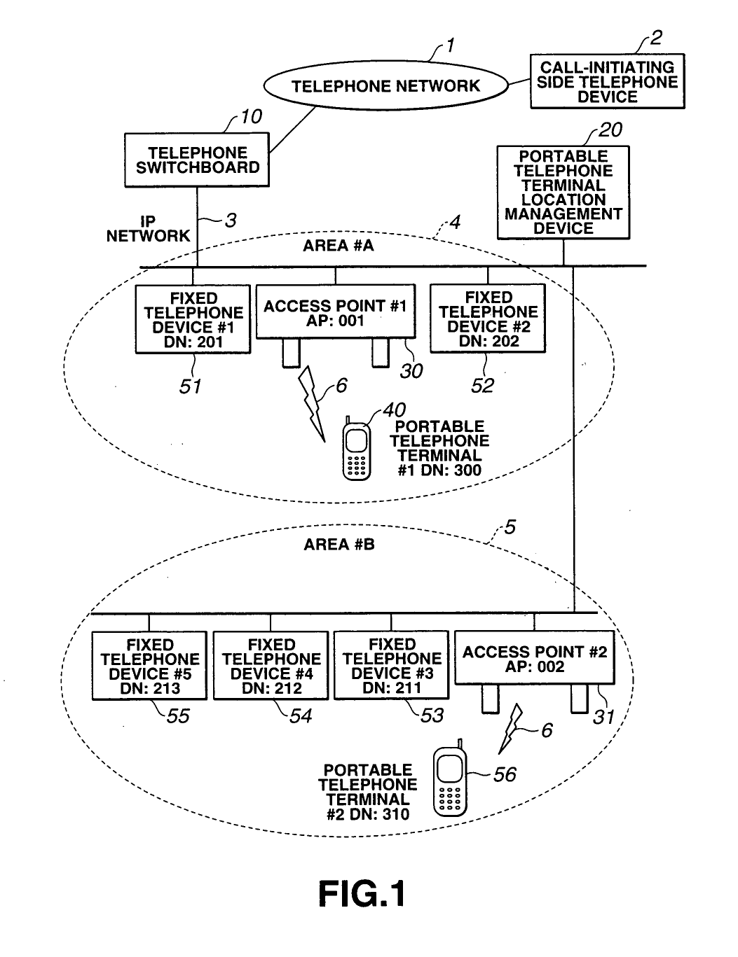

FIG. 1 is a system configuration diagram showing a first constructional example of a telephone switching system according to the present invention.

The telephone switching system in FIG. 1 is constituted by portable telephone terminals (portable telephone terminal #1 (40), portable telephone terminal #2 (56)), access points (access point #1 (30), access point #2 (31)) accommodating the portable telephone terminals, fixed telephone devices (fixed telephone device #1 (51), . . . , fixed telephone device #5 (55)), and a telephone switchboard 10.

The telephone switchboard 10 is connected to a telephone network 1 that performs communications by switching circuit lines, and accommodates, via an IP network 3, a plurality of access points (access point #1 (30), access point #2 (31)) which can accommodate the portable telephone terminals (portable telephone terminal #1 (40), portable telephone terminal #2 (56)) that are present within wireless communications areas (area #A (4), area #B (5)), and a plurality of fixed telephone devices (#1 (51) to #2 (55)) that can communicate by switching packets.

Each access point detects a wireless communication state of the portable telephone terminals (waiting or busy, in area or moving out of area) by using a predetermined number of control channels and a predetermined number of data communications channels, which are provided for wireless communications with the portable telephone terminals, and notifies the status to a portable telephone terminal location management device 20 and the telephone switchboard 10.

Furthermore, each access point controls communications between the portable telephone terminals accommodated by each access point, and the telephone switchboard 10, by means of a gateway function, which performs mutual conversion between a wireless communications protocol for performing wireless communications with the portable telephone terminals 40, and a packet switching protocol for sending and receiving call control data and communications data to/from the telephone switchboard 10.

The portable telephone terminal location management device 20 also has a function to store and manage identification information of the portable telephone terminals currently accommodated by each access point, based on data that is notified from each access point at regular intervals, and, when an inquiry is received from the telephone switchboard 10, the specifies and notifies the access point accommodating the portable telephone terminal.

When performing processing to initiate a call to a call-receiving portable telephone terminal (portable telephone terminal #1 (40), or portable telephone terminal #2 (56)) via the IP network 3, the access point (access point #1 (30), access point #2 (31)) and a wireless communications path 6, if no response to the call initiation processing is detected, the telephone switchboard 10 specifies a given fixed telephone device arranged proximal to the access point (#1 (30), #2 (31)) that accommodates the call-receiving portable telephone terminal, and performs call transferring control to the fixed telephone device.

For example, in the construction shown in FIG. 1, in a case where a call-initiation side telephone device 2 initiates a call to the portable telephone terminal #1 (40) in the area #A (4), if the access point #1 (30) detects no response from the call-destination portable telephone terminal # 1 (40), the telephone switchboard 10 transfers the incoming call to the fixed telephone device #1 (51), or the fixed telephone device #2 (52) proximal to the access point #1 (30), which are arranged proximal to the access point #1 (30), or to both.

Next, explanation is given regarding a control configuration of each constitutive apparatus of the telephone switching system shown in FIG. 1.

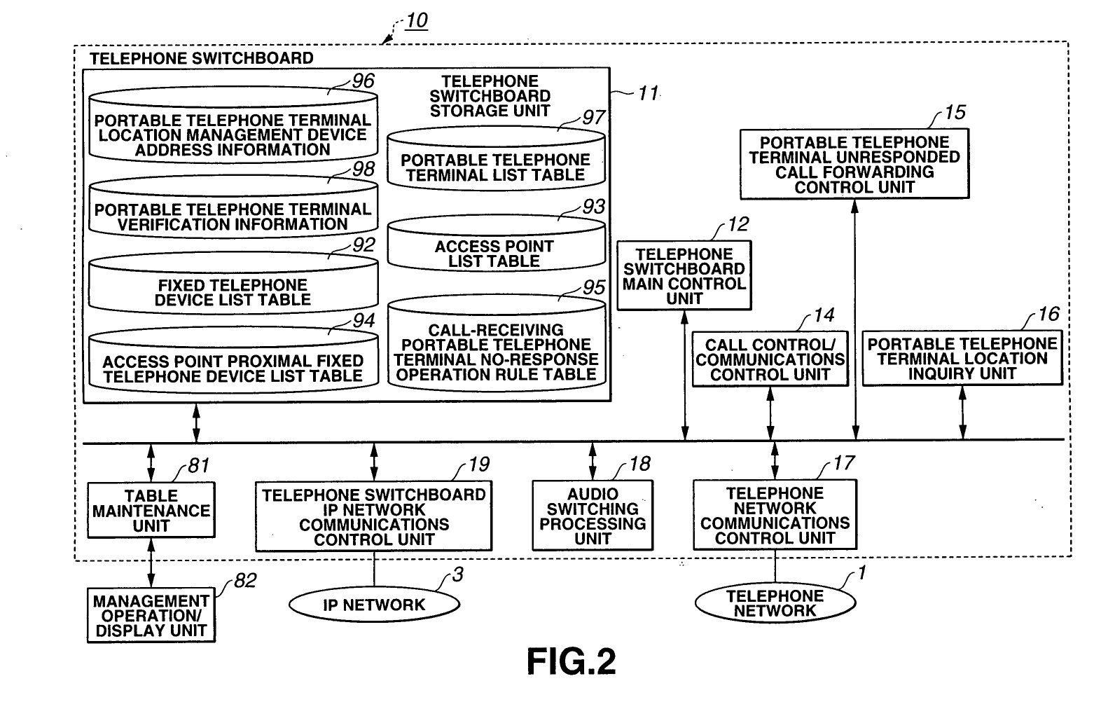

FIG. 2 is a block diagram showing an example of a control configuration of the telephone switchboard, according to the telephone switching system of the present invention.

In FIG. 2, the telephone switchboard 10 is constituted by a telephone switchboard main control unit 12, a telephone switchboard storage unit 11, a call control/communications control unit 14, a portable telephone terminal unresponded call forwarding control unit 15, a portable telephone terminal location inquiry unit 16, a table maintenance unit 81, a telephone switchboard IP network communications control unit 19, an audio switching processing unit 18, and a telephone network communications control unit 17.

The telephone switchboard main control unit 12 is connected to each control unit of the telephone switchboard 10, performs input/output control of data generated between each control block, and performs integrated control of the telephone switchboard 10 overall.

The telephone switchboard storage unit 11 stores and manages portable telephone terminal location management device address information 96, portable telephone terminal verification information 98, a fixed telephone device list table 92, an access point proximal fixed telephone device list table 94, a portable telephone terminal list table 97, an access point list table 93, and a call-receiving portable telephone terminal no-response operation rule table 95.

The portable telephone terminal location management device address information 96 is address information of the portable telephone terminal location management device 20, for the telephone switchboard 10 to perform communications with the portable telephone terminal location management device 20 via the IP network 3.

The portable telephone terminal authorization information 98 stores individual identification information, etc. for verifying the portable telephone terminal approved for communication via the access point (30, 31) accommodated by the telephone switchboard 10.

The fixed telephone device list table 92 stores and manages identification information of the fixed telephone devices accommodated by the telephone switchboard 10, and an IP address of each fixed telephone device.

The access point proximal fixed telephone device list table 94 stores and manages groups of identification information of the fixed telephone devices arranged proximal to the access points accommodated by the telephone switchboard 10.

The portable telephone terminal list table 97 stores and manages pairs consisting of identification information and a portable telephone numbers of the portable telephone terminals 40 accommodated by the telephone switchboard 10.

The access point list table 93 stores and manages pairs consisting of an access point identifier for uniquely specifying within the system each access point (#1 (30), #2 (31)) accommodated by the telephone switchboard 10, and address information corresponding to each access point identifier in the IP network 3.

The call-receiving portable telephone terminal no-response operation rule table 95 pre-sets and manages a call saving method for each access point (#1 (30), #2 (31)), which is to be used when the call going to the portable telephone terminal cannot be established due to no response or due to being busy.

The call control/communications control unit 14 has a gateway conversion function for converting between the circuit switching network communications protocol, and the IP network communications protocol, and performs call control, and communication control after the call is established, in order to conduct communication via the telephone network 1 and the IP network 3.

The portable telephone terminal unresponded call forwarding control unit 15 performs the call transfer to the given fixed telephone device arranged within the telephone switching system, based on the call-receiving portable telephone terminal no-response operation rule table 95 that is stored in the telephone switchboard storage unit, as the call saving processing when the incoming call cannot reach the portable telephone terminal within the wireless communications area of the access points (#1 (30), #2 (31)) accommodated by the telephone switchboard 10.

The portable telephone terminal location inquiry unit 16 performs an inquiring to the portable telephone terminal location management device 20, regarding the identification information of the access point accommodating the desired portable telephone terminal.

The table maintenance unit 81 connects to a management operation/display unit 82, detects maintenance operation performed by a manager using the management operation/display unit 82, and performs maintenance processing of each table stored in the telephone switchboard storage unit 11.

The telephone switchboard IP network communications control unit 19 performs packet communications control that accompanies call control communications, audio communications during communication, and data communications.

The audio switching processing unit 18 performs restoration processing, to restore digitally converted or digitized audio signal (including audio codec) back to analog signal.

The telephone network communications control unit 17 performs communications control by means of a circuit switching format on the telephone device performing communication via the telephone network 1.

Next, explanation is given regarding a control configuration of the portable telephone terminal location management device 20.

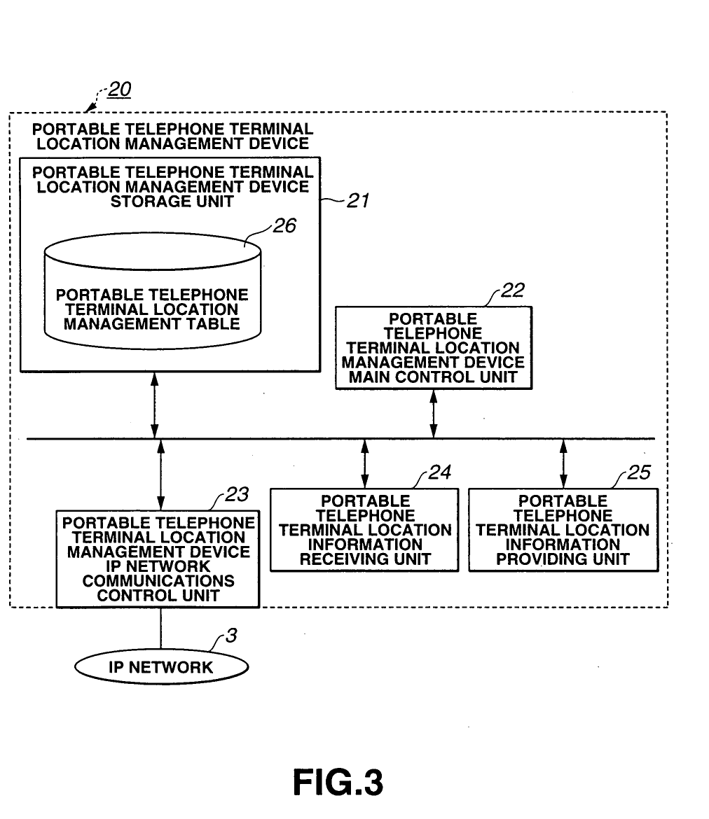

FIG. 3 is a block diagram showing one example of a control configuration of the portable telephone terminal location management device in the telephone switching system of the present invention.

In FIG. 3, the portable telephone terminal location management device 20 is a device which uses the notification from each of the access points (#1 (30), #2 (31)) that are connected via the IP network 3 to store and manage the portable telephone terminal accommodated by each access point, and, in response to the inquiry from the telephone switchboard 10, sends a notification to the access point accommodating the portable telephone terminal.

The portable telephone terminal location management device 20 is constituted having a portable telephone terminal location management device main control unit 22, a portable telephone terminal location information providing unit 25, a portable telephone terminal location information receiving unit 24, and a portable telephone terminal location management device IP network communications control unit 23.

The portable telephone terminal location management device main control unit 22 is connected to the portable telephone terminal location information providing unit 25, the portable telephone terminal location information receiving unit 24 and the portable telephone terminal location management device IP network communications control unit 23, and controls input/output of data generated between each of the control blocks, and performs integrated control of the portable telephone terminal location management device 20 overall.

The portable telephone terminal location management device IP network communications control unit 23 performs packet communications control between the telephone switchboard 10, the access points (#1 (30), #2 (31)) and each of the fixed telephone devices (#1 (51) to #5 (55)), which are connected via the IP network 3. In particular, when a location information inquiry packet is received from the telephone switchboard 10, the content of the packet is notified to the portable telephone terminal location information providing unit 25, and when the location information notification packet is received, the content of the received packet data received is notified to the portable telephone terminal location information receiving unit 24.

The portable telephone terminal location information receiving unit 24 registers the location information of the portable telephone terminals 40 into a portable telephone terminal location management table 26 that is stored in the a portable telephone terminal location management device storage unit 21, based on the content of the location information notification packet received via the portable telephone terminal location management device IP network communications control unit 23, and then the registration result is replied to the packet sending source.

The portable telephone terminal location information providing unit 25 extracts the portable telephone terminal identification information 70 from the location information inquiry packet that was received via the portable telephone terminal location management device IP network communications control unit 23, references the portable telephone terminal location management table 26 stored in the portable telephone terminal location management device storage unit 21 to obtain the identifier of the access point that accommodates the portable telephone terminal 40, creates a response packet that is set with the obtained access point identifier, and sends this to the transmission source of the inquiry packet via the portable telephone terminal location management device IP network communications control unit 23.

Note that, when the power supply of the portable telephone terminal is OFF, if the accommodating access point cannot be specified, the transmission source of the inquiry packet is notified that there is no accommodating access point.

Next, explanation is given regarding a control configuration of the access points.

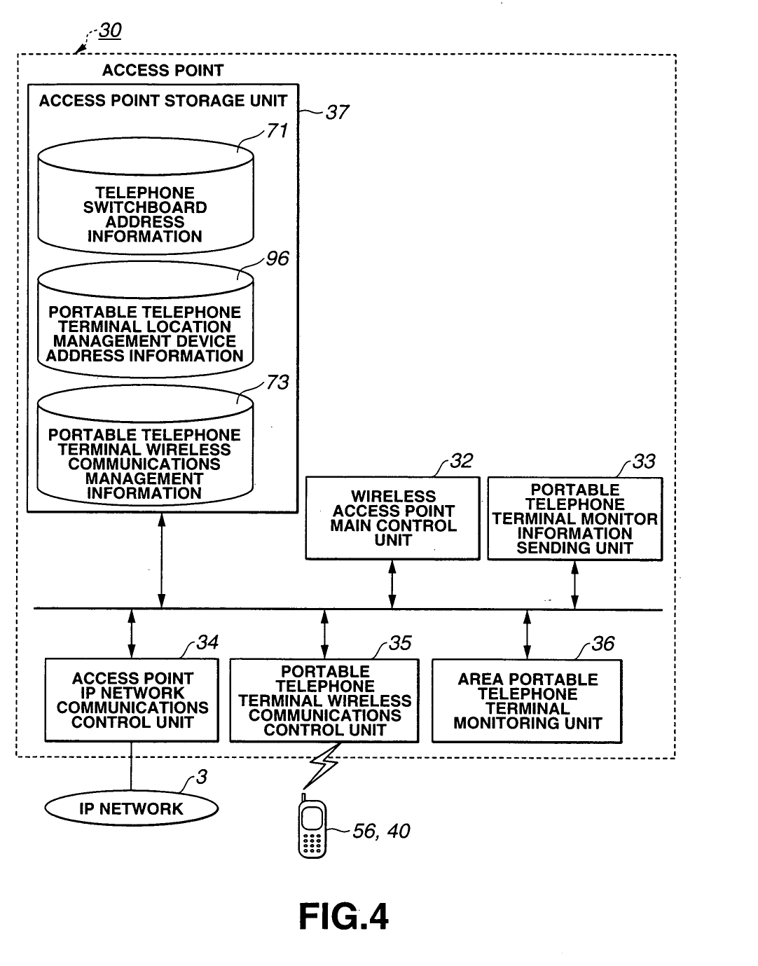

FIG. 4 is a block diagram showing one example of a control configuration of the access points in the telephone switching system of the present invention.

Note that, FIG. 4 illustrates and explains a control configuration of the access point #1 (30).

In FIG. 4, the access point #1 (30) is constituted by an access point main control unit 32, an access point storage unit 37, an access point IP network communications control unit 34, a portable telephone terminal wireless communications control unit 35, an area portable telephone terminal monitoring unit 36 and a portable telephone terminal monitor information sending unit 33.

The access point main control unit 32 is connected to each control block, controls input/output of data generated between each control block, and performs integrated control of the access point #1 (30) overall.

The access point storage unit 37 stores and manages portable telephone terminal wireless communications management information 73, telephone switchboard address information 71, and the portable telephone terminal location management device address information 96.

The portable telephone terminal wireless communications management information 73 is information for storing and managing channel identifiers and data communications channels, which are for specifying multiple control channels and data communications channels that are provided to control wireless communications with the accommodated portable telephone terminal 40, and portable telephone terminal identifiers, which are assigned to each of the control channels and data communications channels.

The portable telephone terminal location management device address information 96 is address information that is assigned to the portable telephone terminal location management device 20 in order to perform packet communications with the portable telephone terminal location management device 20 via the IP network 3.

The telephone switchboard address information 71 is address information for performing packet communications with the telephone switchboard 10 via the IP network 3.

The access point IP network communications control unit 34 controls sending and receiving of packets to/from the IP network 3.

In the wireless communications with the portable telephone terminal 40 present in the wireless communications area, the portable telephone wireless communications control unit 35 manages assignment, and cancellation of assignment, of the control channels and the communications channels, and controls the wireless communications with each of the portable telephone terminals 40 in the wireless communications area.

The area portable telephone terminal monitoring unit 36 detects when the portable telephone 40 (56) moves out of the area or enters into the area, and outputs the portable telephone terminal identifier of the detected portable telephone terminal to the portable telephone terminal monitor information sending unit 33.

The portable telephone terminal monitor information sending unit 33 creates a portable telephone terminal location notification packet, which includes the portable telephone terminal identifier notified from the area portable telephone terminal monitoring unit 36, and its own access point identifier, and sends this packet to the telephone switchboard 10 via the IP network 3.

Next, explanation is given regarding a control configuration of the portable telephone terminal, by illustrating an example of the portable telephone terminal #1 (40) shown in FIG. 1.

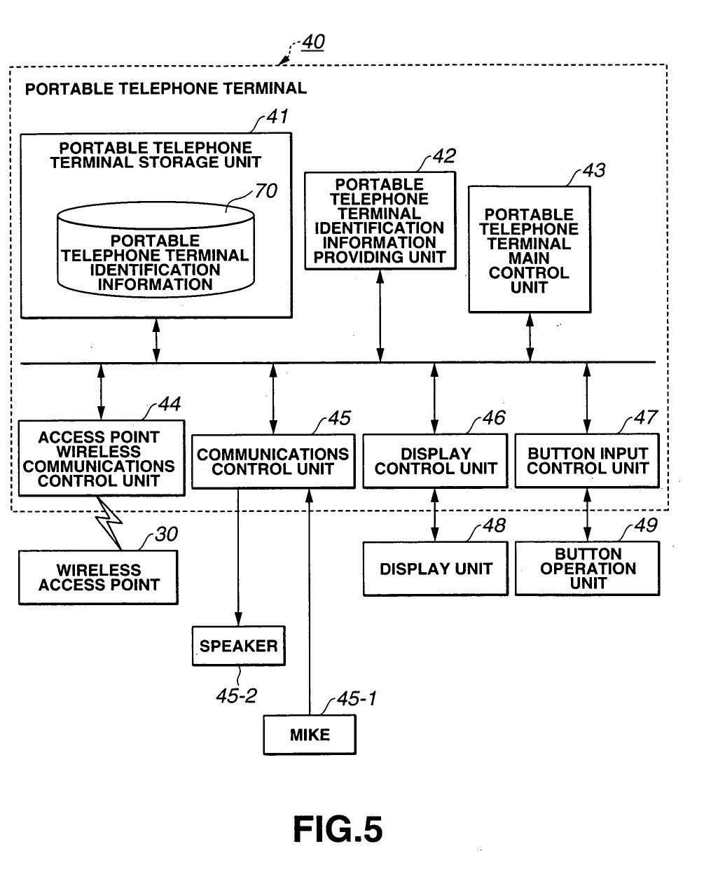

FIG. 5 is a block diagram showing one example of a control configuration of the portable telephone terminal in the telephone switching system of the present invention.

In FIG. 5, the portable telephone terminal #1 (40) is constituted by a portable telephone terminal main control unit 43, a portable telephone terminal storage unit 41, a portable telephone terminal identification information providing unit 42, an access point wireless communications control unit 44, a communication control unit 45, a display control unit 46, and a button input control unit 47.

The portable telephone terminal main control unit 43 controls sending and receiving of data between each control block of the portable telephone terminal #1 (40), and performs integrated control of the portable telephone terminal #1 (40) overall.

The portable telephone terminal storage unit 41 stores a control program, address book, etc. of the portable telephone terminal #1 (40), and particularly stores and manages the individual identification information including the portable telephone terminal number, etc. necessary when the telephone switchboard 10 performs apparatus verification of the portable telephone terminal #1 (40), and the identification numbers of the control channel and the data channel that were established to perform the wireless communications with the access point.

In the case where the inquiry from the access point #1 (30) is generated in the wireless communications with the access point #1 (30) either when establishing the wireless communications path 6 or after the wireless communications path 6 is established, the portable telephone terminal identification information providing unit 42 generates wireless communications data for notifying the stored portable telephone terminal identification information 50 to the portable telephone terminal storage unit 41, and outputs this to the access point wireless communications control unit 44.

The access point wireless communications control unit 44 manages the assignment, and cancellation of assignment, of the control channel and data communications channel necessary for the wireless communications with the access point #1 (30), and performs data transmission control via the wireless communications path 6 that was established to the access point #1 (30).

The communication control unit 45 controls sending and receiving of digital audio data (including audio codec) performed with the access point wireless communications control unit 44, digitizes an audio transmission inputted from a mike 45-1, converts the received digital audio signal into an analog audio signal, and outputs this to a speaker 45-2.

The disk control unit 46 connects to a display unit 48 and outputs display data received via the portable telephone terminal main control unit 43 to the display unit 48.

The button input control unit 47 connects to a button operation unit 49, detects a button input operation by the user, and notifies this to the portable telephone terminal main control unit 43.

Next, in the telephone switching system shown in FIG. 1, and more particularly in the control to forward the call going to the call-receiving portable telephone terminal, explanation will now be given regarding an example of registration made in each table stored in each storage unit of the telephone switchboard 10, the access points (#1 (30), #2 (31)), and the portable telephone terminal location management device 20.

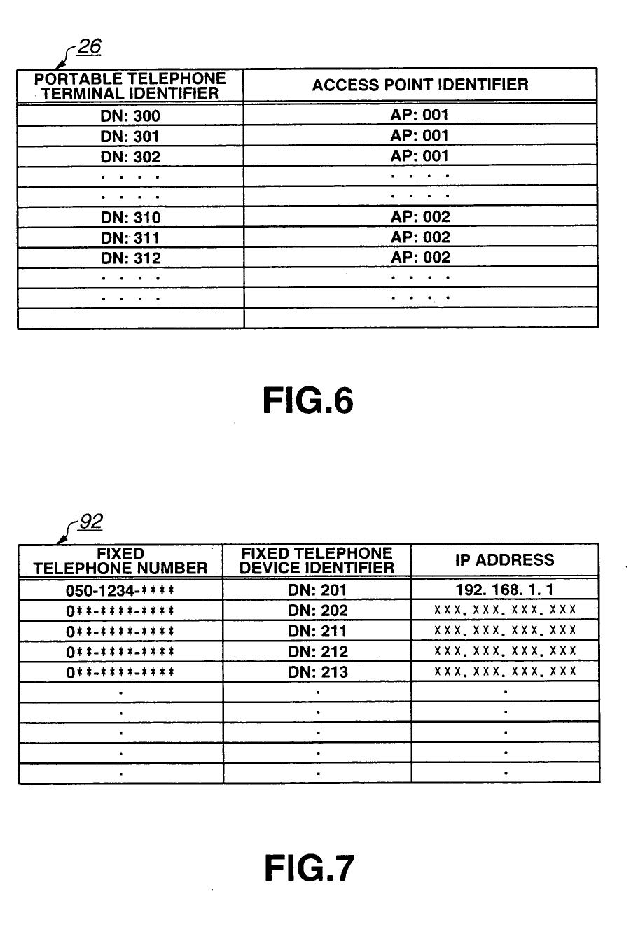

FIG. 6 is a diagram showing of an example of registration in the portable telephone terminal location management table 26 that is stored in the portable telephone terminal location management device 20.

In FIG. 6, the portable telephone terminal location management table 26 is a table that stores and manages the portable telephone terminals present in the wireless communications area of each access point (#1 (30), #2 (31)) accommodated by the telephone switchboard 10.

Entries managed in the portable telephone terminal location management table 26 include the portable telephone terminal identifier and the access point identifier. Both the portable telephone terminal identifier and the access point identifier are identification information assigned to uniquely identify the portable telephone terminals and the access points (#1 (30), #2 (31)) within the telephone switchboard system.

Furthermore, the portable telephone terminal identifiers and the access point identifiers are each set using the identifiers registered in the portable telephone terminal list table 97 and the access point list table 93, which are stored in the storage unit of the telephone switchboard 10 shown in FIG. 1.

FIG. 7 is a diagram showing the content of the settings in the fixed telephone device list table 92, which is stored by the telephone switchboard.

In FIG. 7, the fixed telephone device list table 92 is the items that store and manage the identification information of the fixed telephone devices (51 to 52) accommodated within the telephone switching system.

The fixed telephone device identifier is identification information assigned in advance to uniquely identify the fixed telephone devices within the telephone switching system.

The IP address is address is address information assigned to each fixed telephone device in order to perform the packet communications via the IP network.

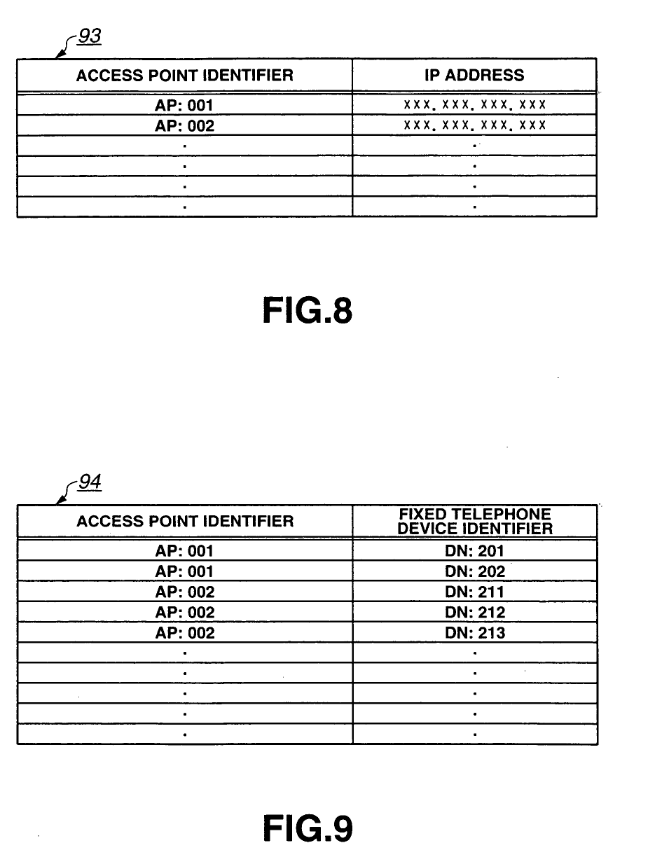

FIG. 8 is a diagram showing an example of registration in the access point list table, which is stored in the portable telephone terminal location management device.

In FIG. 8, the access point list table is a table for managing the IP address assigned to each access point (#1 (30), #2 (31)) accommodated within the telephone switching system. A pair consisting of the access point identifier for uniquely specifying each access point (#1 (30), #2 (31)) within the system, and the IP address, is stored and managed here.

FIG. 9 is a diagram showing the content of the access point proximal fixed telephone device list table, which is stored and managed by the telephone switchboard.

In FIG. 9, the access point proximal fixed telephone device list table 94 is a table for storing and managing a pair consisting of the access point identifier shown in FIG. 8, and its corresponding fixed telephone device identifier, in order to identify the fixed telephone devices arranged proximal to the access points (#1 (30), #2 (31)) accommodated by the telephone switching system, based on the access point list table 93 and the fixed telephone device list table 92.

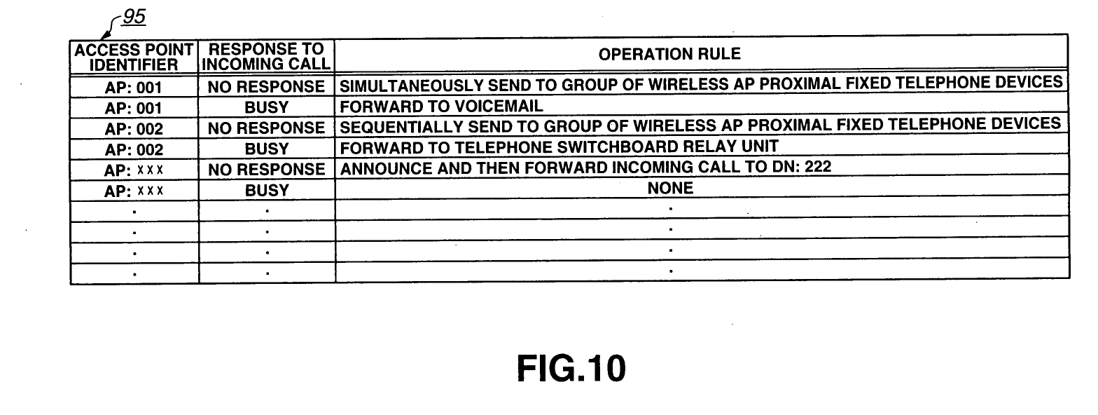

FIG. 10 is a diagram showing one example of data registered in the portable telephone terminal no-response operation rule table, which is stored by the telephone switchboard.

In FIG. 10, the call-receiving portable telephone terminal no-response operation rule table 95 is a table for setting and managing detailed operation rules for each access point, for the telephone switchboard 10 to save the call to the call-receiving portable telephone terminal, in the case where, in the telephone switching system shown in FIG. 1, a call initiation request from the call-initiating telephone device 2 connected to the telephone network 1 or the telephone device within the telephone switching system to the portable telephone terminal is detected, and the response to the call is impossible because the call destination portable telephone terminal 40 (56) is busy or its power supply is turned off, etc.

The entries that are set in the call-receiving portable telephone terminal no-response operation rule table 95 are the access point identifier, a call response, and an operation rule.

The access point identifier is set using the access point identifier defined in the access point list table 93.

The call response is an entry that further breaks down the call response status of the portable telephone terminals (#1 (40), #2 (56)). For example in FIG. 10, the settings are “no response” which indicates that the response timed out, and “busy” which indicates that communication is taking place with another telephone device.

Furthermore, other operation rule registration examples may include a setting to perform the call forwarding to the fixed telephone device arranged proximal to the access point (#1 (30), #2 (31)) that accommodates the call-receiving portable telephone terminal, a setting to forward the call to a relay device of the telephone switchboard 10, a setting to forward the call to a specific fixed telephone device within the telephone switching system, a setting to forward the call to voicemail, etc.

Furthermore, the call forwarding to the fixed telephone device may be performed by a setting for all incoming calls to arrive at multiple fixed telephone devices, a setting to perform call forwarding in a predetermined order to multiple fixed telephone devices, etc.

Note that, FIG. 10 is an example of a case where the call saving methods are managed separately for the identification information of each access point that accommodates the call-receiving portable telephone terminal. However, the present invention is not restricted to this configuration. It is also possible to break down the operation rules and manage them separately per call-receiving portable telephone terminal.

Furthermore, the method for specifying the fixed telephone device that is the call forwarding destination may also be configured so as not to use the identifiers of the access point accommodating the call-receiving portable telephone terminal, but rather provide a separate table that can be referenced directly using the portable telephone terminal identifier to identify each operation rule.

Next, explanation is given regarding call forwarding processing in the case where the telephone switchboard 10 detects no response by the call-receiving portable telephone terminal.

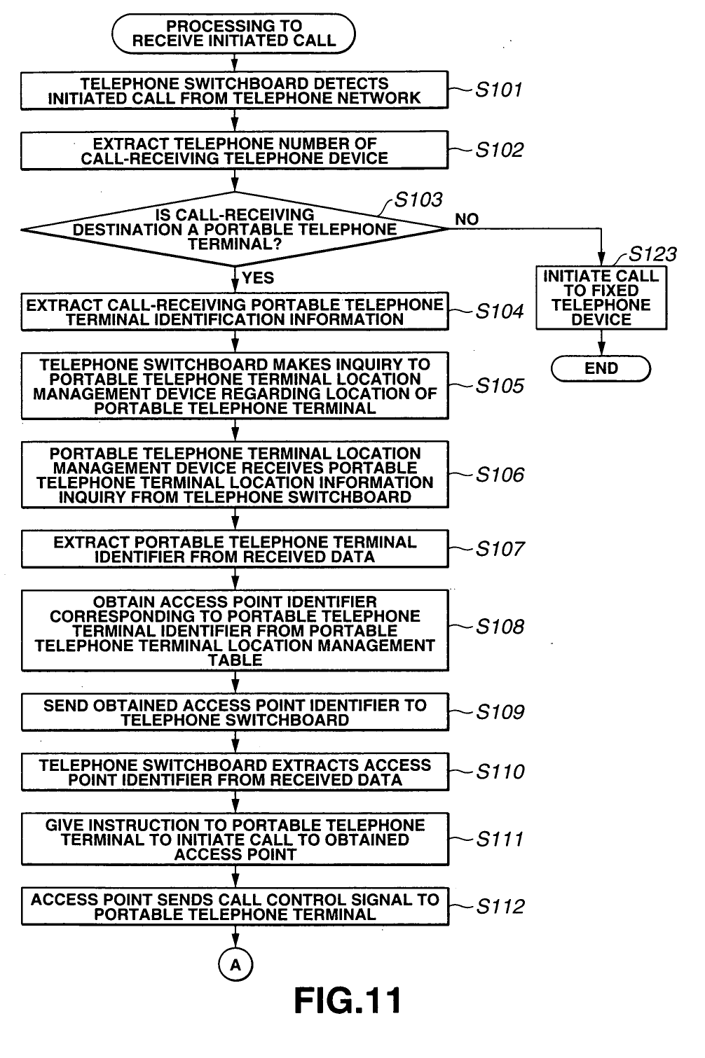

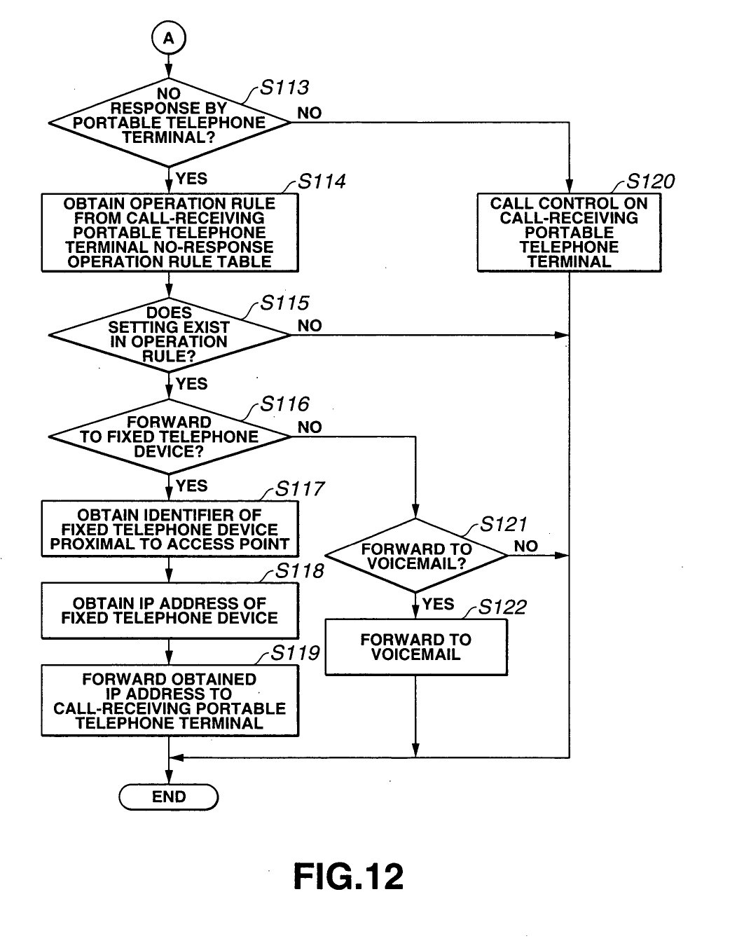

FIG. 11 and FIG. 12 are flowcharts showing processing sequences in the telephone switchboard 10 shown in FIG. 1, which are performed when the call-initiation request to the portable telephone terminals (#1 (40), #2 (56)) and fixed telephone device (#1 (51) to #5 (55)) accommodated in the telephone switchboard 10 is received via the telephone network 1.

Note that, in the explanations of the flowcharts, the reference numbers of the portable telephone terminals and the fixed telephone devices are omitted.

In FIG. 11, when the telephone switchboard 10 detects the call initiated from the call-initiating telephone device 2 via the telephone network 1, the call control/communications control unit 14 of the telephone switchboard 10 detects a call initiation signal via the telephone network communications control unit 17 (step S101), and extracts the telephone number on the call-receiving side from the detected call initiation signal (step S102).

When the extracted telephone number is the number of a fixed telephone device (NO at step S103), the call control/communications control unit 14 references the fixed telephone device list table 92, and obtains the IP address of the fixed telephone device corresponding to the detected telephone number.

The call control/communications control unit 14 of the telephone switchboard 10 establishes the call to the fixed telephone device via the IP network communications control unit and the IP network 3, in accordance with a standard protocol sequence for performing call control on the IP network 3, and then initiates the call to the fixed telephone device (step S123).

On the other hand, when the telephone number of the call-receiving destination is the number of a portable telephone terminal (YES at step S103), the call control/communications control unit 14 references the portable telephone terminal list table 97, and obtains the portable telephone terminal identification information 70 corresponding to the number of the portable telephone terminal 40 (step S104).

The portable telephone terminal location inquiry unit 16 of the telephone switchboard 10 sends the portable telephone terminal location inquiry packet, which contains the obtained portable telephone terminal identifier, to the IP address of the portable telephone terminal location management device 20 that is stored in the telephone switchboard storage unit 11, via the telephone switchboard IP network communications control unit 19 (step S105).

In the portable telephone terminal location management device 20, the portable telephone terminal location information providing unit 25 receives the portable telephone terminal location inquiry packet from the telephone switchboard 10 via the portable telephone terminal location management device IP network communications control unit 23 (step S106), and extracts the portable telephone terminal identifier from the received packet (step S107).

The portable telephone terminal location information providing unit 25 references the portable telephone terminal location management table 26 in the portable telephone terminal location management device storage unit 21, and obtains the access point identifier corresponding to the extracted portable telephone terminal identifier (step S108).

The portable telephone terminal location information providing unit 25 in the portable telephone terminal location management device 20 creates the response packet containing the access point identifier obtained at step S108, and sends this response packet to the telephone switchboard 10 via the portable telephone terminal location management device IP network communications control unit 23 (step S109).

At the telephone switchboard 10, the access point identifier is extracted from the response packet by the portable telephone terminal location inquiry unit 16 that received the response packet from the portable telephone terminal location management device 20 via the telephone switchboard IP network communications control unit 19 (step S110).

The portable telephone terminal location inquiry unit 16 references the access point list table 93 of the telephone switchboard storage unit 11, obtains the IP address corresponding to the extracted access point identifier, notifies the obtained IP address to the call control/communications control unit 14, and gives an instruction for a call establishment request to the portable telephone terminal identifier.

The call control/communications control unit 14 creates a packet for call control, which includes the IP address corresponding to the access point identifier notified from the portable telephone terminal location inquiry unit 16, and the call-receiving side portable telephone terminal identifier, and then sends this packet to the access point accommodating the call-receiving portable telephone terminal (step S111).

At the access point accommodating the call-receiving portable telephone terminal, the portable telephone terminal wireless communications control unit 35 that received the call control packet via the access point IP network communications control unit 34 extracts the portable telephone terminal identifier of the call-receiving portable telephone terminal from the received packet, and detects that the call has been generated to the call-receiving portable telephone terminal.

The portable telephone terminal wireless communications control unit 35 uses the wireless communications control channel established between the access point itself and the call-receiving portable telephone terminal, and the data communications channel assigned to the call-receiving portable telephone terminal, to send the call initiation signal to the call-receiving portable telephone terminal, and monitors for the response from the call-receiving portable telephone terminal (step S112).

When the call-receiving portable telephone terminal responds via the access point (NO at step S113), call control is performed on the call-receiving portable telephone terminal (step S120).

When the call going to the call-receiving portable telephone terminal cannot be established due to no response by the call-receiving portable telephone terminal or communication with another telephone device (YES at step S113), the portable telephone terminal wireless communications control unit 35 of the access point that accommodates the call-receiving portable telephone terminal sends a response packet notifying that the call control on the call-receiving portable telephone terminal failed to the telephone switchboard 10 via the access point IP network communications control unit 34.

At the telephone switchboard 10, when the call control/communications control unit 14 receives the response packet indicating the call initiation failure via the telephone switchboard IP network communications control unit 19, the call control/communications control unit 14 outputs the non-responding call-receiving portable telephone terminal identifier, the access point identifier, and the type of portable telephone terminal no-response (no response, busy) to the portable telephone terminal unresponded call forwarding control unit 15.

Then, the portable telephone terminal unresponded call forwarding control unit 15 obtains the operation rule corresponding to the access point identifier that was notified (step S114), and judges whether the operation call saving rule is set in the content of the operation rule that was obtained (step S115).

When no operation rule has been set (NO at step S115), the telephone switchboard 10 ends the call reception processing.

On the other hand, when the operation rule is set for the access point accommodating the call-receiving portable telephone terminal (YES at step S115) and call forwarding to the fixed telephone device is set (YES at step S116), the portable telephone terminal unresponded call forwarding control unit 15 references the access point proximal fixed telephone device list table 94, and obtains the fixed telephone device identifier of the fixed telephone device that corresponds to the access point identifier (step S117).

The portable telephone terminal unresponded call forwarding control unit 15 references the fixed telephone device list table 92, and obtains the IP address of the fixed telephone device that corresponding to the obtained fixed telephone device identifier (step S118).

The portable telephone terminal unresponded call forwarding control unit 15 notifies the obtained fixed telephone device IP address to the call control/communications control unit 14, and gives an instruction to forward the call that was addressed to the call-receiving portable telephone terminal to the notified IP address (step S119).

Returning to step S116, when the content of the obtained operation instructions is a setting for anything other than call forwarding to a fixed telephone device (NO at step S116), for example when it is a setting to forward to voicemail (in the call-receiving portable telephone terminal no-response operation rule table in FIG. 4, the access point identifier is “AP:001” and the call-receiving portable telephone terminal response is “busy”) (YES at step S121), the call going to the call-receiving portable telephone terminal is forwarded to the voicemail (step S122).

Note that, when there are multiple fixed telephone devices receiving the forwarding of the call to the call-receiving portable telephone terminal, the call forwarding control for forwarding to the fixed telephone device at step S117 and step S118 may be performed by performing controls to identify fixed telephone devices to which calls can be forwarded based on a pre-set priority sequence and then forward the calls in sequence, or to forward simultaneously to the multiple fixed telephone devices to which calls can be forwarded.

Furthermore, in the processing by the portable telephone terminal location management device shown in step S108 in FIG. 11, when the power supply to the call-receiving portable telephone terminal is OFF, and the access point accommodating the call-destination portable telephone terminal cannot be specified, the telephone switchboard 10 notifies a message to the call-initiating telephone device to indicate that the power supply is OFF, and ends the call reception processing.

Furthermore, in the processing shown in the flowcharts in FIG. 11 and FIG. 12, instead of control to initiates the call via the telephone network 1, it is also possible to perform control to forward the initiated call from the fixed telephone device or the portable telephone terminal accommodated by the telephone switchboard 10.

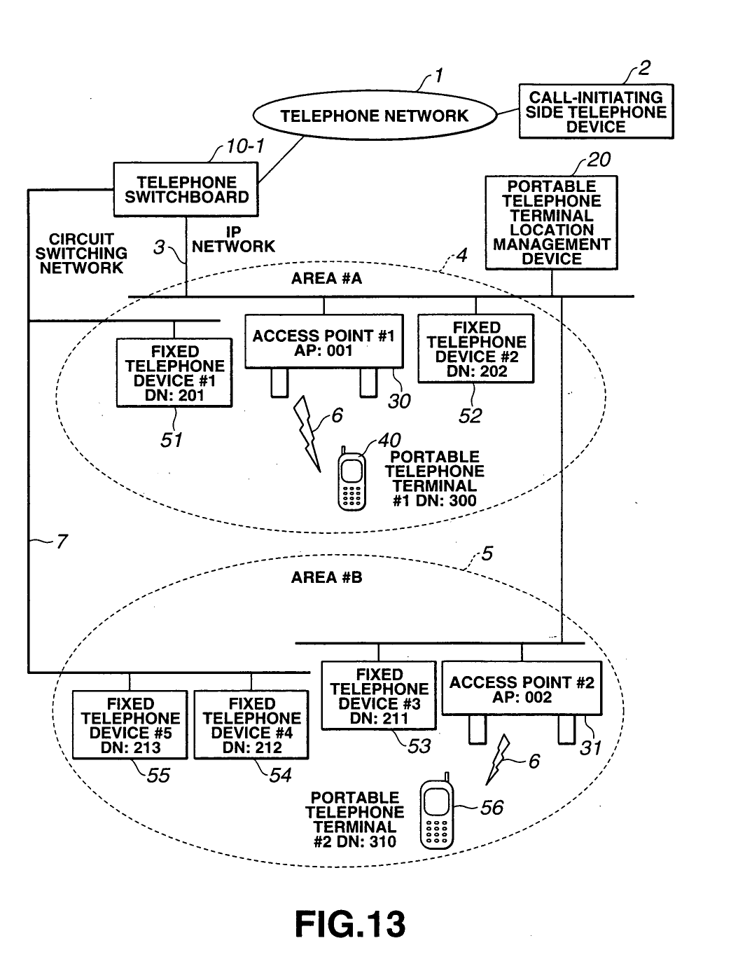

Next, FIG. 13 shows an example of the call saving method and the telephone switchboard in the telephone switching system of the present invention, which is different from the system configuration shown in FIG. 1.

The telephone switchboard 10-1 shown in FIG. 13 is a second system configuration diagram of a case in which the fixed telephone device #1 (51), the fixed telephone device #4 (54) and the fixed telephone device #5 (55) shown in the construction in FIG. 1 are connected to a circuit switching network 7, and are accommodated as a digital telephone device and an analog telephone device for performing communications by switching circuit lines.

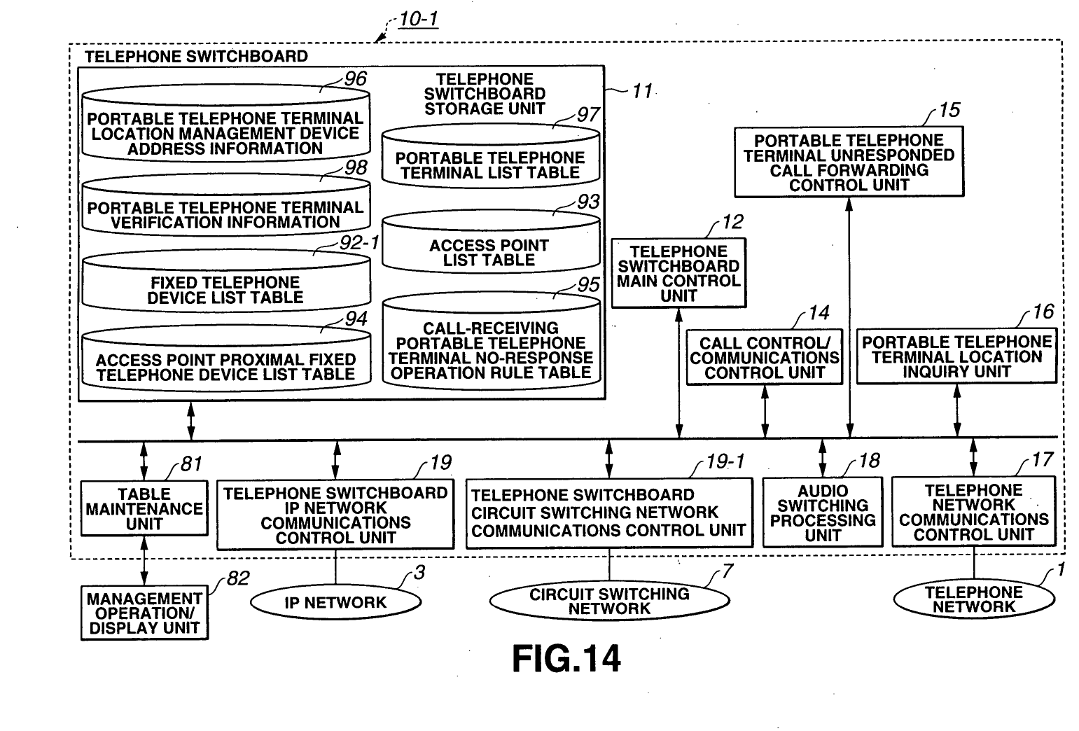

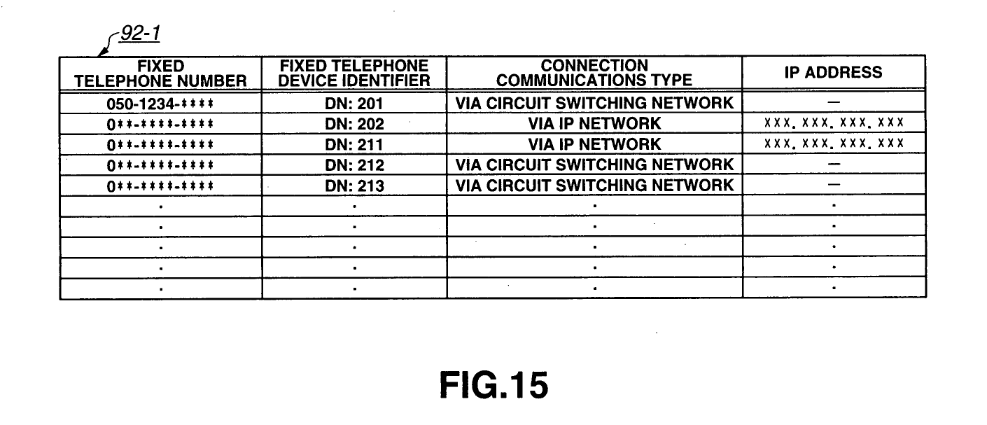

Furthermore, in the telephone switchboard 10-1, as shown in FIG. 14, in addition to the control configuration of the telephone switchboard 10 shown in FIG. 2 there is also a telephone switchboard circuit switching network communications control unit 19-1. Furthermore, in addition to the management entries in the fixed telephone device list table 92, the telephone switchboard storage unit 11 also stores and manages a table (FIG. 15) with entries for managing the type of communications (via IP network or via circuit switching network) used with each fixed telephone device.

Furthermore, in the construction in FIG. 14, the call control/communications control unit 14 of the telephone switchboard 10-1 obtains the communications type used for the fixed telephone device, based on the identification information of the fixed telephone device on the call receiving side, when performing the call initiation or the call forwarding processing to the fixed telephone device accommodated by the telephone switchboard 10-1.

Then, the call control/communications control unit 14 specifies the communications path (IP network 3 or circuit switching network 7) based on the obtained fixed telephone device communications type, and performs the telephone switching processing with the communications control unit (the telephone switchboard IP network communications control unit 19, or the telephone switchboard circuit switching network communications control unit 19-1) that corresponds to the communications path that was specified.

What is claimed is:

1. A call saving method used in a telephone switching system having a telephone switchboard accommodating a plurality of access points for connecting to a plurality of portable telephone terminals, and a plurality of fixed telephone devices, comprising:
storing in which access point's range the portable telephone terminal is present while linking the portable telephone terminal and the access point;
specifying, when an incoming call arrives at the portable telephone terminal via the access point based on the stored information and the portable telephone terminal does not respond, at least one fixed telephone device proximal to the access point; and
forwarding the incoming call going to the portable telephone terminal to the specified fixed telephone device.

2. The call saving method used in the telephone switching system according to claim 1, wherein at least one fixed telephone device proximal to the access point is stored in correspondence to the access point, and at least one fixed telephone device proximal to the access point is specified based on the stored information.

3. The call saving method used in the telephone switching system according to claim 1, wherein at least one fixed telephone device proximal to the access point is specified based on address information of the access point.

4. The call saving method used in the telephone switching system according to claim 1, wherein when an incoming call arrives at the portable telephone terminal via the access point and the portable telephone terminal does not respond, the incoming call going to the portable telephone terminal is sent simultaneously to a plurality of the specified fixed telephone devices.

5. The call saving method used in the telephone switching system according to claim 1, wherein when an incoming call arrives at the portable telephone terminal via the access point and the portable telephone terminal does not respond, the incoming call going to the portable telephone terminal is sent sequentially to a plurality of the specified fixed telephone devices in a predetermined order.

6. The call saving method used in the telephone switchboard according to claim 1, wherein a call saving operation is set for when an incoming call arrives at the portable telephone terminal via the access point and the portable telephone terminal does not respond, and
in a case where call forwarding to the fixed telephone device proximal to the access point is set in the call saving operation, the incoming call going to the portable telephone terminal is forwarded to the specified fixed telephone device.

7. The call saving method used in the telephone switching system according to claim 6, wherein the call saving operation for when the portable telephone terminal does not respond is set corresponding to each access point.

8. A telephone switchboard in a telephone switching system accommodating a plurality of access points for connecting to a plurality of portable telephone terminals, and a plurality of fixed telephone devices, the telephone switchboard comprising:
portable telephone terminal location storing means for storing in which access point's range the portable telephone terminal is present while linking the portable telephone terminal and the access point;
fixed telephone device specifying means for specifying at least one fixed telephone device proximal to the access point when an incoming call arrives at the portable telephone terminal via the access point based on the stored information in the portable telephone terminal location storing means and the portable telephone terminal does not respond; and
call forwarding means for forwarding the incoming call going to the portable telephone terminal to the fixed telephone device specified by the fixed telephone device specifying means.

9. The telephone switchboard according to claim 8, wherein the fixed telephone device specifying means has storing means for storing at least one fixed telephone device proximal to the access point in correspondence with the access point, and specifies at least one fixed telephone device proximal to the access point based on the information stored in the storing means.

10. The telephone switchboard according to claim 8, wherein the fixed telephone device specifying means specifies at least one fixed telephone device proximal to the access point, based on address information of the access point.

11. The telephone switchboard according to claim 8, wherein the call forwarding means sends the incoming call going to the portable telephone terminal simultaneously to a plurality of the fixed telephone devices specified by the fixed telephone device specifying means.

12. The telephone switchboard according to claim 8, wherein the call forwarding means sequentially sends the incoming call going to the portable telephone terminal to a plurality of the fixed telephone devices specified by the fixed telephone device specifying means according to a predetermined order.

13. The telephone switchboard according to claim 8, further comprising call saving operation setting means for setting a call saving operation for when an incoming call arrives at the portable telephone terminal via the access point and the portable telephone terminal does not respond,
wherein, in a case where call forwarding to the fixed telephone device proximal to the access point has been set by the call saving operation setting means, the call forwarding means forwards the incoming call going to the portable telephone terminal to the fixed telephone device specified by the fixed telephone device specifying means.

14. The telephone switchboard according to claim 13, wherein the call saving operation setting means sets the call saving operation for when the portable telephone terminal does not respond, in correspondence to each access point.
